(19) United States
(12) Patent Application Publication
(10) Pub. No.: US 2004/0122720 A1
(43) Pub. Date: Jun. 24, 2004

(54) Meta-coordination of distributed computations

(76) Inventors: Thomas A. Mikalsen, Cold Spring, NY (US); Isabelle M. Rouvellou, New York, NY (US); Stefan Tai, New York, NY (US)

Correspondence Address: THE LAW OFFICE OF IDO TUCHMAN, 69-60 108ST., SUITE 503, FOREST HILLS, NY, 11375, US

(21) Appl. No.: 10/325,423

(22) Filed: Dec. 20, 2002

(51) Int. Cl. G06F 17/60

(52) U.S. Cl. 705/7

(57) ABSTRACT

A method, system, and computer program product for managing individual operations of service providers in a distributed network. The distributed network includes a client having at least one coordination outcome requirement to be satisfied. The invention includes a first determining module configured to determine a set of coordination outcome requirements. A second determining module is configured to determine predefined operation patterns of the service providers. A first observing module is configured to observe client requests for one or more individual operation invocations on the service providers. A second observing module is configured to observe service provider responses to the operation invocations. The invention also includes a coordinating module configured to coordinate the individual operations according to the predefined operation patterns, the client requests, and the service provider responses such that one coordination outcome requirement from the set of coordination outcome requirements is achieved.

### FIELD OF THE INVENTION

The present invention relates generally to coordination of Web services, and, more specifically, to a Web services platform configured to coordinate and automate Web transactions between transaction participants while maintaining the autonomy of each participant.

### BACKGROUND

As Internet connectivity continues to increase, many services traditionally requiring human intervention are being automated to work over the Internet. For example, it is now possible to shop for groceries, make airline reservations, and obtain a fishing license over the World Wide Web. While such Web services greatly enhance the usability of the Internet, they remain difficult to coordinate into global transactions that span across diverse transactional (and non-transactional) service implementations.

Web services are difficult to coordinate because Web service providers typically develop their services independently of one another. Unlike conventional middleware transactions, no common transaction semantic, transaction context representation, and coordination protocol can be assumed to exist for transaction participants in a Web services environment. It is more likely that participants are autonomous (with respect to their implementation and execution environment), that different, seemingly incompatible transaction models and middleware technologies may be involved in the same Web transaction, and that context representation and service coordination and management must be achieved in a decoupled, decentralized manner.

Consider, for example, a travel booking scenario where a user, also referred to herein as a client, wishes to arrange a trip using three independent travel services; a flights Web service, a rooms Web service, and a taxis Web service. Assume that the client wants to reserve two flights, one hotel room and multiple taxis using these independent Web services. Furthermore, the client wishes to establish transaction dependency between the services so that only the following outcomes of the combined use of the Web services are possible:

1. the two flights reservations, the hotel reservation, and the taxis reservation are all committed,

2. the two flights reservations and the hotel reservation are committed, but the taxis reservation is aborted, or

3. the two flights reservations, the hotel reservation, and the taxis reservation are all aborted.

Therefore, the flights reservations and the hotel reservation in combination are vital to the success of the global client transaction, whereas the taxis reservation is not critical to the success of the transaction (but is nevertheless part of the transaction).

Presently, clients typically need to manually program the use of Web services to ensure that exactly one of the desired outcomes is reached. This is a complex exercise; a possible simple solution (neglecting any management of system failures) can be illustrated by the following pseudo-code:

| | |
|---|---|
| cR = Rooms.reserveRoom | // reserve room |
| pF1 = Flights.reserveFlight | // reserve flight1 |
| pF2 = Flights.reserveFlight | // reserve flight2 |
| Taxis.newBooking { | |
| Taxis.addLeg * | |
| pT = Taxis.submit | // prepare taxis |
| } | |
| if (cR && pF1 && pF2) { | // commit condition |
| cF1 = Flights.confirmFlight | // commit flight1 |
| cF2 = Flights.confirmFlight | // commit flight2 |
| if (cF1 && cF2) { | |
| if (pT) { | |
| cT = Taxis.confirmBooking | // commit taxis |
| } | |
| } else { | |
| Rooms.cancelResv | // cancel room |
| if (pT) { | |
| Taxis.cancelBooking | // abort taxis |
| } | |
| } else { | // rollback |
| if (pF1) { | |
| Flights.cancelResv | // abort flight1 |
| } | |
| if (pF2) { | |
| Flights.cancelResv | // abort flight2 |
| } | |
| if (pT) { | |
| Taxis.cancelBooking | // abort taxis |
| } | |
| if (cR) { | |
| Rooms.cancelResv | // cancel room |
| } | |
| } | |

Thus, conventional Internet technology generally lacks a framework for integrating various autonomous Web services into one or more global transactions. Clients are generally forced to generate ad hock solutions with implicit transaction behavior buried in complex code with no clean separation of transaction concerns. Such code is often error prone and difficult to maintain.

### SUMMARY OF THE INVENTION

The present invention addresses the above-mentioned limitations of traditional Web services environments. The present invention uses a transactional attitude framework to help create reliable transactional compositions from Web services with diverse transactional behavior. The transactional attitudes can be used to capture and communicate otherwise implicit transactional semantics and requirements, without compromising the autonomy of the individual transaction participants. Thus, the framework enables clients to create Web transaction without requiring transaction participants to agree on a common transaction semantic, transaction context representation, and coordination protocol.

One aspect of the present invention involves a method for managing individual operations of service providers in a distributed system. The distributed system includes a client having at least one coordination outcome requirement to be satisfied. The method comprises a first determining operation to determine a set of coordination outcome requirements. A second determining operation is configured to determine predefined operation patterns of the service providers. A first observing operation examines client requests for one or more individual operation invocations on service providers. A second observing operation examines service provider responses to the operation invocations. A coordinating operation coordinates the individual operations according to the predefined operation patterns, the client requests, and the service provider responses such that one coordination outcome requirement from the set of coordination outcome requirements is achieved.

Another aspect of the invention is a system for managing individual operations of service providers in a distributed network for a client having at least one coordination outcome requirement to be satisfied. The system includes a first determining module configured to determine a set of coordination outcome requirements. A second determining module is configured to determine predefined operation patterns of the service providers. A first observing module is configured to observe client requests for one or more individual operation invocations on the service providers. A second observing module is configured to observe service provider responses to the operation invocations. The system also includes a coordinating module configured to coordinate the individual operations according to the predefined operation patterns, the client requests, and the service provider responses such that one coordination outcome requirement from the set of coordination outcome requirements is achieved.

Yet another aspect of the invention is a computer program product embodied in a tangible media. The computer program product includes program codes to: determine a set of coordination outcome requirements, determine predefined operation patterns of the service providers, observe client requests for one or more individual operation invocations on the service providers, observe service provider responses to the operation invocations, and coordinate the individual operations according to the predefined operation patterns, the client requests, and the service provider responses such that one coordination outcome requirement from the set of coordination outcome requirements is achieved.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary network environment embodying the present invention.

FIG. 2 illustrates provider transactional attitudes of an exemplary travel booking scenario contemplated by the present invention.

FIG. 3 shows one embodiment of a middleware server contemplated by the present invention.

FIG. 4 shows a flowchart of middleware server operations performed by one embodiment of the present invention.

### DETAILED DESCRIPTION OF THE INVENTION

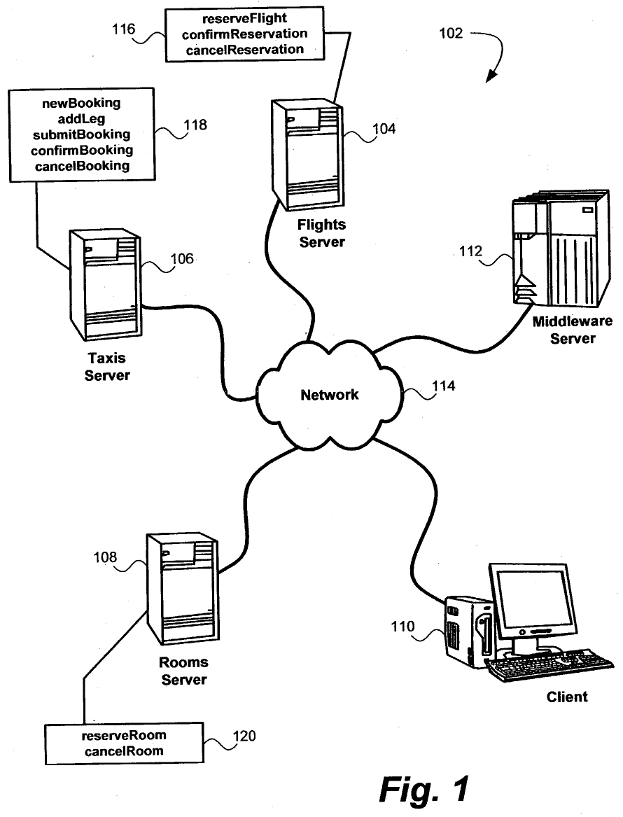

The present invention beneficially integrates diverse and autonomous service participants in a distributed network environment, and helps achieve global, client-specified transaction outcomes using such autonomous participants reliably and automatically. The invention enables a client to generate a global transaction without requiring transaction participants to agree on a common transaction semantic, transaction context representation, and coordination protocol. The invention is described herein with reference to FIGS. 1-4. When referring to the figures, like structures and elements shown throughout are indicated with like reference numerals.

In FIG. 1, an exemplary network environment 102 embodying one implementation of the present invention is shown. It is noted that the network environment 102 is presented for illustration purposes only, and is representative of countless system configurations in which the invention may be implemented. Thus, the present invention should not be considered limited to the configurations shown and discussed herein.

In one embodiment of the invention, the environment 102 supports the standard Web Services Description Language (WSDL). WSDL is used to describe a Web service in terms of ports (addresses implementing the service), port types (the abstract definition of operations and ordered exchanges of messages), and bindings (the concrete definition of which packaging protocols, such as Simple Object Access Protocol (SOAP), are used). WSDL is an interface standard that abstracts from any platform and programming language specific details of how application code is actually invoked. More information about WSDL can be found at, E. Christensen et al., Web Services Description Language (WSDL) 1.1, W3C Note (Mar. 15, 2001), http://www.w3.org/TR/wsdl.html.

As shown, the environment 102 includes a flights server 104, a taxis server 106, a rooms server 108, and client 110, and a middleware server 112 coupled to a computer network 114. The computer network 114 may be any network known in the art for effectuating communications between the various servers 104, 106, 108, 112 and client 110 within the network environment 102. Thus, the network 114 can be a local area network (LAN), a wide area network (WAN), or a combination thereof. It is contemplated that the network 114 may be configured as a public network, such as the Internet, and/or a private network, and may include various topologies and protocols know to those skilled in the art. In a particular embodiment of the invention, the network 114 supports diverse Internet protocols, such as hypertext transfer protocol (HTTP), hypertext transfer protocol reliable (HTTPR), simple mail transfer protocol (SMTP), and file transfer protocol (FTP).

The flights server 104, taxis server 106 and rooms server 108 are representative of independent service providers within the network environment 102. These service providers are autonomous and can have different transaction models, different transaction context representation, and/or different coordination protocol. Thus, the service providers cannot be assumed to implement any particular Internet transaction technology. Furthermore, each service provider is capable of performing at least one individual transaction. As used herein, a transaction is defined broadly and may include a computation, task, action, operation and other electronic devices.

The client 110 is representative of an entity or user requiring at least one transaction to be performed by service providers within the network environment 102. The client 110 is typically a general-purpose computer, but it is contemplated that the client 110 may be any Web-enabled device capable of communicating via the network 114. Thus, the client 110 may include personal digital assistants (PDAs), cellular phones, and the like.

For illustration purposes, it assumed that the client 110 wishes to reserve two flights, one hotel room and multiple taxis using the flights server 104, rooms server 108 and taxis server 106 respectively. Furthermore, the client wants to establish transaction dependency between the services so that only the following outcomes of the combined use of the Web services are possible:

1. the two flights reservations, the hotel reservation, and the taxis reservation are all committed,

2. the two flights reservations and the hotel reservation are committed, but the taxis reservation is aborted, or

3. the two flights reservations, the hotel reservation, and the taxis reservation are all aborted.

Therefore, the flights reservations and the hotel reservation in combination are vital to the success of the global client transaction, whereas the taxis reservation is not critical to the success of the transaction (but is nevertheless part of the transaction).

As described in detail below, the middleware server 112 provides global context management for execution monitoring, transaction completion, failure-detection, and recovery of group transactions. The middleware server 112 acts as an intermediary between the client 110 and the servers 104, 106, 108, coordinating individual transactions according to predefined transaction patterns such that one outcome requirement from a set of outcome requirements specified by the client 110 is achieved.

As mentioned above, each of the service providers is capable of performing at least one individual transaction. For example, the flights server 104 may provide three transactions 116: reserveFlight, confirmReservation, and cancelReservation. The reserveFlight operation returns a reservation number to the client 110, which the client 110 needs to either confirm a reservation or cancel a reservation. This service can be defined by the following WSDL specification:

```
<?xml version=“1.0” encoding=“UTF-8” ?>
<!-- Flights reservation Web service -->
<definitions name=“Flights”
  xmlns=“http://schemas.xmlsoap.org/wsdl/”
...
<!-- abstract messages -->
...
<message name=“ReserveFlightOut”>
  <part name=“resvNo” type=“xsd:string”/>
</message>
<message name=“ConfirmReservationIn”>
  <part name=“resvNo” type=“xsd:string”/>
</message>
<message name=“CancelReservationIn”>
  <part name=“resvNo” type=“xsd:string”/>
</message>
...
<!-- port type -->
<portType name=“FlightsPortType”>
<operation name=“reserveFlight”>
  <input message=“ReserveFlightIn”/>
  <output message=“ReserveFlightOut”/>
</operation>
<operation name=“confirmReservation”>
  <input message=“ConfirmReservationIn”/>
  <output message=“ConfirmReservationOut”/>
</operation>
<operation name=“cancelReservation”>
  <input message=“CancelReservationIn”/>
  <output message=“CancelReservationOut”/>
</operation>
</portType>
</definitions>
```

The taxis server 106 offers operations to group multiple taxi leg requests into a single (atomic) reservation, and may include the following transactions 118: newBooking, addLeg, submitBooking, confirmBooking, and cancelBooking. The newBooking operation is used to start a reservation; it returns a booking number which the client 110 uses for all subsequent operations. The addLeg operation is used to add taxi legs, the submitBooking operation is used to submit the request, and the confirmBooking operation and the cancelBooking operations are used to complete or cancel a reservation. The taxis server 106 may be described as follows:

```
<?xml version=“1.0” encoding=“UTF-8” ?>
<!-- Taxis reservation Web service -->
<definitions name=“Taxis”
  xmlns=“http://schemas.xmlsoap.org/wsdl/”
...
<!-- abstract messages -->
...
<message name=“NewBookingOut”>
  <part name=“bookingNo” type=“xsd:string”/>
</message>
<message name=“ConfirmBookingOut”>
  <part name=“confNo” type=“xsd:string”/>
</message>
...
<!-- port type -->
<portType name=“TaxisPortType”>
<operation name=“newBooking”>
  <input message=“NewBookingIn”/>
  <output message=“NewBookingOut”/>
</operation>
<operation name=“addLeg”> ...
</operation>
<operation name=“submitBooking”> ...
</operation>
<operation name=“confirmBooking”>
  <input message=“ConfirmBookingIn”/>
  <output message=“ConfirmBookingOut”/>
</operation>
<operation name=“cancelBooking”> ...
</operation>
</portType>
</definitions>
```

The rooms server 108 provides two transaction operations 120: reserveRoom and cancelReservation. The reserveRoom operation returns a confirmation number to the client 110, which is needed for the client 110 to cancel (undo) a reservation later on. The following WSDL fragment shows the interface of the rooms server 108:

```
<?xml version=“1.0” encoding=“UTF-8” ?>
<!-- Hotel room reservation Web service -->
<definitions name=“Rooms”
  xmlns=“http://schemas.xmlsoap.org/wsdl/”
...>
<!-- types -->
<types ...>
<schema>
<complexType name=“ConfInfo”>
<sequence>
  <element name=“confNo” type=“xsd:string”/>
...
</sequence>
</schema>
</complexType>
</types>
<!-- abstract messages -->
...
<message name=“ReserveRoomOut”>
  <part name=“conf” type=“types:ConfInfo”/>
</message>
<message name=“CancelReservationIn”>
  <part name=“confNo” type=“xsd:string”/>
</message>
...
<!-- port type -->
<portType name=“RoomsPortType”>
<operation name=“reserveRoom”>
  <input message=“ReserveRoomIn”/>
  <output message=“ReserveRoomOut”/>
</operation>
<operation name=“cancelReservation”>
  <input message=“CancelReservationIn”/>
  <outputmessage=“CancelReservationOut”/>
</operation>
</portType>
</definitions>
```

Thus, each server 104, 106, 108 implements a different transactional behavior, which, using standard WSDL, is only implicitly described. For example, in the flights server 104, the cancelReservation operation aborts a tentative reservation, whereas in the rooms server 108, the cancelReservation operation compensates for a completed reservation.

In order to avoid ad hoc programming of compositions of Web services that have different transactional semantics, the concept of Provider Transactional Attitudes (PTAs) is introduced. PTAs are a mechanism for service providers to explicitly describe their specific transactional behavior. By making transactional semantics explicit, PTAs can be used in automating the composition of individual transactional services into larger transactional patterns, while maintaining the autonomy of the individual services.

A PTA includes the name of an abstract transactional pattern, plus any additional port-specific information needed to make the pattern concrete. The abstract pattern implies a well-defined state machine describing the valid transactional states, state transitions, and transition-triggering events. The name and semantic of each state is implied by the name of the transactional pattern. State transitions are triggered by externally observable events, such as operation invocations on ports and timeouts. To complete a pattern, a service provider must:

1. identify transactional port operations (i.e., the port operations that can trigger transactional-state transitions),

2. describe how invocations on these operations are associated with corresponding state machines instances (e.g., operation correlation encoding), and

3. describe how transactional-operation outcomes are encoded.

In one embodiment of the invention, standard WSDL extensibility mechanisms (so called extensibility elements) are used to annotate port bindings with transactional semantics (i.e., to define an XML vocabulary for transactions). Such transactional attitude (TxA) definitions include the following extension elements (applied to wsdl:binding):

1. a binding extension element for declaring the transactional attitude (i.e., transactional pattern) of a port,

2. operation extension elements for declaring transactional-event triggering operations,

3. input/output extension elements for describing operation correlation encoding, and

4. output/fault extension elements for describing operation-outcome encoding.

For example, a TxA port binding element is used to declare a port's transactional attitude: annotating a port binding with

<txa:binding

attitude=‘pending-commit’/>

declares that the port has a pending-commit attitude towards transactions. The name pending-commit refers to a well-defined TxA transactional pattern.

In a particular embodiment of the invention, the TxA vocabulary consists of three provider transactional attitudes:

1. “pending-commit” (PC),

2. “group-pending-commit” (GPC), and

3. “commit-compensate” (CC).

Such PTAs describe transactional behavior common to many Web services, and, in particular, these PTAs can be used to describe the transactional behavior of the flights server 104, taxis server 106 and rooms server 108 in the travel booking scenario discussed above. It is contemplated that other attitudes supported by the TxA may be included without departing from the scope and spirit of the invention.

The pending-commit (PC) attitude describes a transactional port of a single Web service where the effect of a single forward operation invocation can be held in a pending state; the operation-effect remains pending until the subsequent occurrence of an event (e.g., the invocation of a commit or abort operation) triggers either acceptance or rejection (of the operation-effect).

In one embodiment of the invention, forward operations are annotated with a <txa:forwardOperation> element. The effect of a forward operation is brought to a pending state if the operation is invoked successfully; otherwise, the effect is rejected. The effect of a forward operation can be explicitly realized by invoking a commit operation. Commit operations are annotated using a <txa:commitOperation> operation extension element. The effect of a forward operation can be explicitly dismissed by invoking an abort operation. Abort operations are annotated using a <txa:abortOperation> operation extension element.

In order to associate a forward operation with a commit (or abort) operation, a PC attitude must include a correlation encoding.

TxA provides the <txa:simpleCorrelation> input/output extension element for describing simple correlation encodings, where a correlation identifier is embedded in a message part. This element allows the provider to specify the part, and optionally the sub-part (e.g., using an XML Path Language (XPath) expression), of a message that holds the correlation identifier.

Returning to the travel booking scenario from above, the flights server 104 implicitly describes the transactional semantics of a pending-commit PTA: the process of reserving a flight includes a pending state, before the reservation is either committed (using the confirmReservation operation) or aborted (using the cancelReservation operation). This transactional behavior can be made explicit in a WSDL binding using TxA extension elements as follows:

```
<binding name=“FlightsPortBinding”
  type=“tns:FlightsPortType”>
<txa:binding attitude=“pending-commit”/>
<operation name=“reserveFlight”>
  <txa:forwardOperation/>
  <output>
  <txa:simpleCorrelation partName=“resvNo”/>
  </output>
</operation>
<operation name=“confirmReservation”>
  <txa:commitOperation/>
  <input>
  <txa:simpleCorrelation partName=“resvNo”/>
  </input>
</operation>
<operation name=“cancelReservation”>
  <txa:abortOperation/>
  <input>
  <txa:simpleCorrelation partName=“resvNo”/>
  </input>
</operation>
</binding>
```

It is noted that the bindings described herein are abbreviated to save space; a complete binding would likely include additional communication protocol elements, such as SOAP extension elements.

The group-pending-commit (GPC) attitude describes a transactional port of a single Web service where the effects of a group of forward operation invocations can be held in a pending state; the group-effect remains pending until the subsequent occurrence of an event (e.g., the invocation of a commit or abort operation) triggers either acceptance or rejection (of the group-effect).

A new operation group is created either explicitly with a begin operation, or implicitly as part of a forward operation. Explicit begin operations are annotated with a <txa:beginOperation> element. Forward operations are annotated with a <txa:forwardOperation> element.

The group-effect is brought to a pending state by invoking a single end operation. End operations are annotated with a <txa:endOperation> element. The group-effect is brought to a pending state if the end operation is invoked successfully; otherwise, the groupeffect is rejected.

The group-effect of all forward operations can be explicitly accepted by invoking a single commit operation. A commit operation is annotated with a <txa:commitOperation> element. The group-effect is accepted if the commit operation is invoked successfully; otherwise, the group-effect is rejected.

The group-effect of all forward operations can be explicitly rejected by invoking a single abort operation. Abort operations are annotated using the <txa:abortOperation> element.

In order to associate individual operations (forward operations, end operations, etc.) with a group, a GPC attitude must include a correlation encoding. As with the pending-commit PTA (see above), simple correlation encodings can be described using the <txa:simpleCorrelation> element.

The taxis server 118 implicitly describes a group-pending-commit PTA: the Web service provides control operations to begin, end, commit or abort a group of actions, and it provides a forward operation that represents the group action. This transactional behavior can be described using TxA as follows:

```
<binding name=“BookingBinding”
  type=“tns:BookingPortType”>
<txa:binding
  attitude=“group-pending-commit”/>
<operation name=“newBooking”>
<txa:beginOperation/>
<output>
  <txa:simpleCorrelation
    partName=“bookingNo”/>
</output>
</operation>
<operation name=“addLeg”>
<txa:forwardOperation/>
<input>
  <txa:simpleCorrelation
    partName=“bookingNo”/>
</input>
</operation>
<operation name=“submitBooking”>
<txa:endOperation/>
<input>
  <txa:simpleCorrelation
    partName=“bookingNo”/>
</input>
</operation>
<operation name=“confirmBooking”>
<txa:commitOperation/>
<input>
  <txa:simpleCorrelation
    partName=“bookingNo”/>
</input>
</operation>
<operation name=“cancelBooking”>
<txa:abortOperation/>
<input>
  <txa:simpleCorrelation
    partName=“bookingNo”/>
</input>
</operation>
</binding>
```

The commit-compensate (CC) attitude describes a transactional port of a single Web service where the effect of a single forward operation invocation is immediately accepted, yet can later be semantically reversed by invoking an associated compensation operation on the port.

Forward operations are annotated with a <txa:forwardOperation> element. The effect of a forward operation is immediately accepted if the operation is invoked successfully; otherwise, the effect is rejected.

The effect of a forward operation can be semantically reversed by invoking a compensation operation. Compensation operations are annotated using a <txa:compensateOperation> element.

The transactional behavior of the rooms server 108 is consistent with the commit-compensate PTA: an incoming request that can be executed is immediately committed. A compensating operation (the cancelReservation operation) is defined for a client to undo a previously committed reservation. This behavior can be made explicit using the following TxA port binding:

```
<binding name=“ReservationBinding”
  type=“tns:ReservationPortType”>
<txa:binding attitude=“commit-compensate”/>
<operation name=“reserveRoom”>
<txa:forwardOperation/>
<input>
<output>
  <txa:simpleCorrelation
    partName=“conf” select=“confNo”/>
</output>
</operation>
<operation name=“cancelReservation”>
<txa:compensateOperation/>
<input>
  <txa:simpleCorrelation partName=“confNo”/>
</input>
</operation>
</binding>
```

In the examples above, a default operation-outcome encoding is assumed. Each operation, in all three Web services 104, 106, 108, has an associated single fault message (which has been elided for conceptual simplification). If an operation generates a fault, then the operation-outcome is failure; otherwise, the operation-outcome is success. The meaning of success and failure for a given operation is defined by the PTA; for example, failure of a endOperation in the group-pending-commit PTA results in the immediate rejection of the groupeffect (as if an abortOperation was invoked).

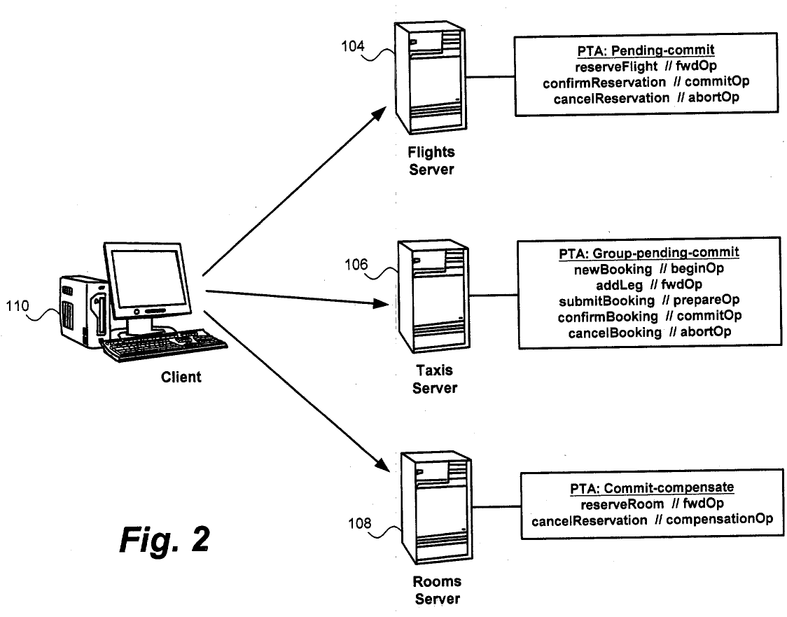

FIG. 2 illustrates in summary the provider transactional attitudes of the three autonomous Web services of the travel booking scenario. Using TxA, the otherwise implicit transactional behavior of the Web services is now explicit as part of the WSDL interface.

The TxA framework of the present invention further describes client expectations explicitly using Client Transactional Attitudes (CTAs). A client's transactional attitude is established by its use of a particular WSDL port type to manage (create, complete, etc.) Web transactions, where the port type represents some pre-defined transactional pattern. Within the scope of a Web transaction, the client executes one or more named activities, where each activity represents a provider transaction (associated with some PTA) executing within the context of the larger Web transaction.

The client initiates an activity by binding to an activity port, which serves as a proxy to a participating provider's transactional port. Each activity port represents a unique provider transaction executing within the context of the client's Web transaction. When using an activity port, the client may invoke only the forward operations of the provider; that is to say, the client cannot invoke completion operations (commit, abort, and compensation operations). Activities and activity ports are described in more detail below.

The flexible atom (FA) attitude describes a client transaction where a set of client activities (i.e., provider transactions) are grouped into an atomic group that can have one out of a set of defined group outcomes; that is to say, some activities are declared to be critical to the success of the transaction, whereas other activities are part of the transaction though not pivotal to its success. The client specifies the acceptable outcomes as an outcome condition, described in terms of the success or failure of the individual activities, and when ready (i.e., after executing the forward operations of these activities), requests the completion of the flexible atom according to that condition. The TxA middleware (described below) then attempts to satisfy the, condition by invoking the appropriate completion operations on the providers represented by the associated activities.

The code below illustrates the client for the Travel Booking example using the TxA:

```
// Create a new FlexibleAtom Web txn
flexAtom = txaPort.newWebTransaction
    (“FlexibleAtomPortType”);
// Client activities
FlightsPortType flight1 =
  flexAtom.newActivity(“flight-1”,
    “FlightsPort”,“ url:FlightsService.wsdl”);
FlightsPortType flight2=
  flexAtom.newActivity(“flight-2”,
    “FlightsPort”,“ url:FlightsService.wsdl”);
RoomsPortType room1 =
  flexAtom.newActivity(“room-1”,
    “RoomsPort”,“ url:RoomsService.wsdl”);
TaxisPortType taxis =
  flexAtom.newActivity(“taxis”,
    “TaxisPort”,“ url:TaxisService.wsdl”);
// invoke forward operations on participants
room1.reserveRoom(/*...*/);
flight1.reserveFlight(/*...*/);
flight2.reserveFlight(/*...*/);
String t = taxis.newBooking(/*...*/);
  taxis.addLeg(t,/*...*/);
  taxis.addLeg(t,/*...*/);
taxis.submit(t);
// Establish condition (valid outcomes)
String condition = “(flight-1 && flight-2 &&
room-1 && (taxis || !taxis)) || !(flight-1 ||
flight-2 || room-1 || taxis)”;
// End the atom
String outcome = flexAtom.endAtom(condition);
```

Here, the client 110 initiates four activities named flight-1, flight-2, room-1, and taxis. Each activity is bound to an activity port using newActivity operation. The activity ports serve as proxies to the provider's transactional ports, allowing invocations to be associated with the correct client Web transaction. The client invokes forward operations using the activity ports, and then establishes an outcome condition representing the desired group outcomes and requests that the flexible atom Web transaction be completed according to this condition.

The present invention uses explicit transactional semantic descriptions, such as the PTAs and CTAs described above, to automate the reliable execution of Web transactions. To support such automation, the TxA framework includes middleware which acts as an intermediary between a client and a set of Web service providers. This middleware harmonizes client transactional requirements (CTAs) with the diverse transactional capabilities of individual providers (PTAs), and reliably executes and monitors Web transactions accordingly.

In general, the TxA middleware provides the following functions:

1. understand and support some set of PTAs (and the proposed TxA binding extensions used to describe them)

2. understand and support some set of CTAs (i.e., provide port and port bindings for the supported CTA port types)

3. intercept all transactional interaction between a client and the participating Web service providers

4. establish and manage Web transaction contexts (i.e., global contexts) on behalf of the client

5. associate transactional interactions (messages) with the corresponding global contexts and participating local provider transaction contexts

6. provide records (logs) of the activities performed for each (global) transaction

To ensure reliable execution, the TxA middleware typically includes

1. a persistent log of all ongoing transactions and their state,

2. a persistent log of all relevant transactional-state transformations for, each global transaction, and

3. a time service that serves for detecting timeouts in transactional interactions with participants.

The TxA middleware includes interfaces to manage Web transactions according to specific CTAs. Once a client ends a TxA transaction, it is the middleware's responsibility to reliably perform the completion of the transaction (e.g., invoking commit, abort, and compensation operations on the providers). Thus, the TxA middleware must further comprise components that monitor participants to guarantee that completion operations are successfully performed. Returning to FIG. 1, it can therefore be appreciated that the middleware server 112 is itself a Web service, and serves as an intermediary between a transactional client 110 and one or more transactional providers 104, 106, 108.

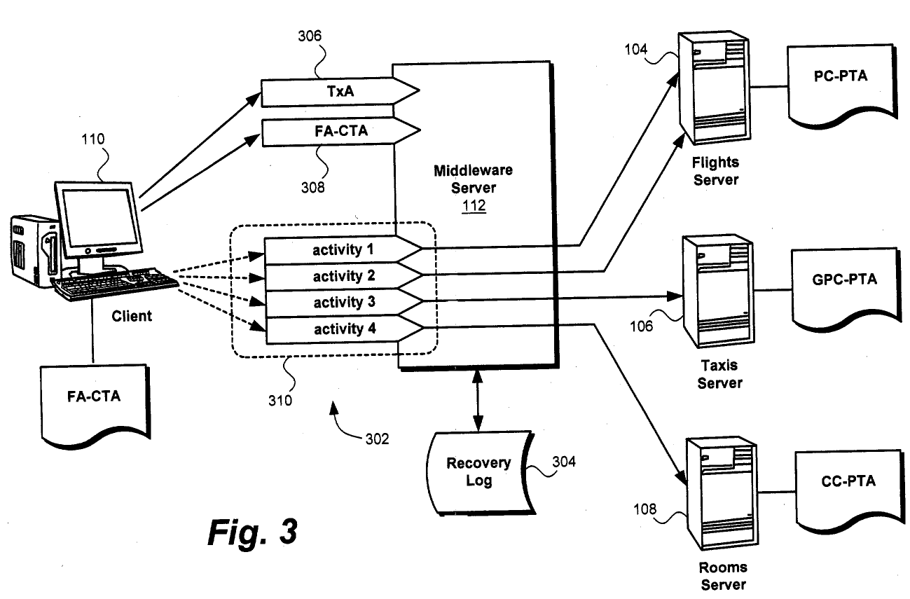

In FIG. 3, the middleware server 112 supporting the flexible atom CTA and the pending-commit, group-pending-commiLt, and commit-compensate PTAs described above is shown. In one embodiment of the invention, the middleware server 112 comprises three types of ports 302 and a recovery log 304.

The TxA port 306 provides general Web transaction and configuration operations, and is independent of any particular CTA. An example is the newWebTransaction operation.

The CTA ports 308 are used to manage Web transactions associated with specific CTAs. In FIG. 3, a CTA port 308 supporting the flexible atom CTA is shown. Examples include the newActivity and endAtom operations.

Activity ports 310 are proxy ports through which the client 110 interacts with providers 104, 106, 108. An activity port 310 is created dynamically (by the middleware server 112) whenever a client 110 initiates an activity (representing a provider transaction) within the context of a Web transaction (for example, with the Flexible Atom newActivity operation).

A recovery log 304 is used to durably record all critical interactions and transactional state transitions, in order to recover in the event of a failure.

During operation, client 110 uses the TxA port 306 to create a new flexible atom Web transaction:

flexAtom = txaPort.newWebTransaction
(“FlexibleAtomPortType”);

The client 110 then initiates activities using the Flexible Atom newActivity operation. For example, the client 110 creates an activity called “flight-b 1” associated with the FlightsPort port provided by the Web service described in url:FlightsService.wsdl (the specified WSDL file is expected to include the PTA of the provider):

```
FlightsPortType flight1 =
  flexAtom.newActivity(“flight-1”,
    “FlightsPort”,“ url:FlightsService.wsdl”)
```

In response, the middleware server 112 creates a new activity port for the activity named “flight-I”, and associates it with the given client's Web transaction. Subsequent client invocations on this port, which are expected to be forward operations within the same provider transaction context, are routed to the FlightsPort port of the FlightsService provider. For example, the invocation flight1.reserveFlight is routed to the FlightsService provider, which creates a new provider transaction context identified by the returned reservation number correlator.

For each client activity, the middleware server 112 observes the transactional events (e.g., client invocations) that can affect the state of the associated provider transaction. In particular, the middleware server 112 intercepts all messages exchanged through its activity ports 310, and uses the provider's PTA to determine the meaning of these messages within the context of the provider's transaction. In doing so, the middleware server 112 reflects the state of all provider transactions associated with the client's activity (i.e., the client's Web transaction). The middleware server 112 persistently records the events associated with critical state transitions in the recovery log 304, and uses these records to recover in the event of a failure.

When completing a Web transaction, the middleware server 112 drives the associated provider transactions to completion according to the client's CTA. For example, when completing a flexible atom Web transaction, the middleware server 112 evaluates the activities named in the outcome condition, and attempts to satisfy this condition by invoking the appropriate completion operations (e.g., commit, abort, compensate) on the providers represented by those activities.

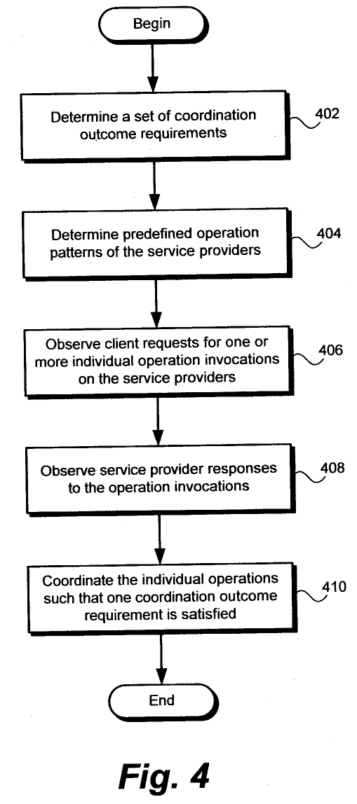

In FIG. 4, a flowchart of middleware server operations performed by one embodiment of the present invention is shown. It should be remarked that the logical operations shown may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

Operational flow begins with determining operation 402. During this operation, a set of coordination outcome requirements is determined by the middleware server. In a particular embodiment of the invention the coordinated outcome requirements are client specified transaction outcomes. It is contemplated, however, that the coordinated outcome requirements may include non-transactional requirements. For example, the present invention can be utilized in redundant processing systems where redundant computations (such as a credit check) are performed using different autonomous interfaces that are polled by a middleware server. Furthermore, determining operation 402 may include an intermediate operation of receiving the set of coordination outcome requirements from the client. After determining operation 402 is completed, control flow passes to determining operation 404.

At determining operation 404, the middleware server determines predefined operation patterns of the service providers. The predefined provider pattern (i.e. PTA) may include multiple invocations on a provider. For example, an operation pattern may include a forward operation followed by a compensating operation. The first operation invocation creates a context that subsequent operation invocations require. A pattern may require that a provider specify how it externally represents (e.g., XML schema type) and communicates (i.e., location within a message) such context. In TxA, patterns use the <simpleCorrelation> element to specify a correlator (i.e., correlation schema type and location within a message) that identifies the context. Thus, in one embodiment of the invention, the predefined operation patterns include coordination capabilities and semantics of service provider operations. Furthermore, the determining operation 404 may include sub-operations such as determining context representation for provider operations and determining semantically equivalent operations for operations in the predefined operation patterns. As mentioned above, the predefined patterns may specify valid transactional states, state transitions, and transition-triggering events, as well as the name and semantic of each state. Once determining operation 404 is completed, control passes to observing operation 406.

At observing operation 406, the middleware server checks client requests for one or more individual operation invocations on the service providers. In a particular embodiment of the invention, the middleware server functions as a proxy to the client, intercepting a client request to a service provider, examining the request's content, and then passing the request to the service provider. The middleware server also checks service provider responses to the operation invocations at observing operation 408. Thus, the middleware server may also function as a proxy to the service provider, intercepting an operation response to the client, examining the response's content, and then passing the response to the client. After the observing operations 406, 408 are completed, control passes to coordinating operation 410.

At coordinating operation 410, the individual operations are systematically controlled by the middleware server according to predefined operation patterns such that one coordination outcome requirement from the set of coordinated outcome requirements is achieved. This operation involves creating a global context on behalf of the client (e.g., in response to a “newFlexAtom” operation”). The global context is used to represent the scope of individual provider contexts to which the client's outcome applies. The predefined operation patterns are used to describe the behavior of the service providers, and may include the capabilities and semantics of service provider operations. The coordination operation 410 also takes into account the client requests and service provider responses observed during observing operations 406, 408. Once a coordination outcome requirement is achieved, control flow ends.

Thus, the TxA framework of the present invention facilitates creation of reliable transactional compositions from Web services with diverse transactional behavior. The transactional attitudes can be used to capture and communicate otherwise implicit transactional semantics and requirements, without compromising the autonomy of the individual transaction participants. Furthermore, provider transactional attitudes (PTAs) can use WSDL extension elements to annotate Web service provider interfaces for Web transactions, according to well-defined transactional patterns; client transactional attitudes (CTAs) are described in terms of well-defined WSDL port types and outcome acceptance criteria. And the middleware system can use these explicit transactional attitude descriptions to reliably execute web transactions, offering a conceptual design for a specific middleware implementation that meets these requirements.

The TxA framework uniquely enables a client to program a Web transaction without requiring transaction participants to agree on a common transaction semantic, transaction context representation, and coordination protocol. In addition, the concept of transactional attitudes follows and promotes a clean separation of concerns for software engineering. Transactional properties can be isolated from other aspects of a service description, allowing, for example, capability-based service queries.

Regarding the system implementation, the design of the TxA framework can use standard Web services technology only; WSDL and existing WSDL extension mechanisms are sufficient to support the idea of transactional attitudes. The design is also open to accommodate some technologies emerging in the highly dynamic field of Web services.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for managing individual operations of service providers in a distributed system for a client having at least one coordination outcome requirement to be satisfied, the method comprising:
determining a set of coordination outcome requirements;
determining predefined operation patterns of the service providers;
observing client requests for one or more individual operation invocations on the service providers;
observing service provider responses to the one or more operation invocations; and
coordinating the individual operations according to the predefined operation patterns, the client requests, and the service provider responses such that one coordination outcome requirement from the set of coordination outcome requirements is achieved.

2. The method of claim 1, wherein determining predefined operation patterns includes determining coordination capabilities and semantics of service provider operations.

3. The method of claim 1, wherein determining predefined operation patterns includes determining semantically equivalent operations for operations in the predefined operation patterns.

4. The method of claim 1, wherein determining predefined operation patterns includes determining context representations for operations in the predefined operation patterns.

5. The method of claim 1, wherein determining the set of coordination outcome requirement includes receiving the set of outcome requirements from the client.

6. The method of claim 1, wherein observing client requests includes intercepting client requests to the service providers.

7. The method of claim 1, wherein observing service provider responses includes intercepting service provider responses to the client.

8. The method of claim 1, further comprising determining if at least one coordination outcome requirement of the set of coordination outcome requirements is possible.

9. The method of claim 1, further comprising determining if the coordination outcome requirement has expired.

10. A system for managing individual operations of service providers in a distributed network for a client having at least one coordination outcome requirement to be satisfied, the method comprising:
a first determining module configured to determine a set of coordination outcome requirements;
a second determining module configured to determine predefined operation patterns of the service providers;
a first observing module configured to observe client requests for one or more individual operation invocations on the service providers;
a second observing module configured to observe service provider responses to the one or more operation invocations; and
a coordinating module configured to coordinate the individual operations according to the predefined operation patterns, the client requests, and the service provider responses such that one coordination outcome requirement from the set of coordination outcome requirements is achieved.

11. The system of claim 10, wherein the predefined operation patterns include coordination capabilities and semantics of service provider operations.

12. The system of claim 10, wherein the second determining module is further configured to determine semantically equivalent operations for operations in the predefined operation patterns.

13. The system of claim 10, wherein the second determining module is further configured to determine context representations for operations in the predefined operation patterns.

14. The system of claim 10, wherein the first determining module is further configured to receive the set of outcome requirements from the client.

15. The system of claim 10, wherein the first observing module is further configured to intercept client requests to the service providers.

16. The system of claim 10, wherein the second observing module is further configured to intercept service provider responses to the client.

17. The system of claim 10, wherein the coordinating module is further configured to determine if at least one coordination outcome requirement of the set of coordination outcome requirements is possible.

18. The system of claim 10, wherein the coordinating module is further configured to determine if the coordination outcome requirement has expired.

19. The system of claim 10, further comprising a persistent log configured to record the client requests and the service provider responses.

20. A computer program product embodied in a tangible media comprising:
computer readable program codes coupled to the tangible media for managing individual operations of service providers in a distributed system for a client having at least one coordination outcome requirement to be satisfied, the computer readable program codes configured to cause the program to:
determine a set of coordination outcome requirements;
determine predefined operation patterns of the service providers;
observe client requests for one or more individual operation invocations on the service providers;
observe service provider responses to the one or more operation invocations; and
coordinate the individual operations according to the predefined operation patterns, the client requests, and the service provider responses such that one coordination outcome requirement from the set of coordination outcome requirements is achieved.

21. The computer program product of claim 20, wherein the predefined operation patterns include coordination capabilities and semantics of service provider operations.

22. The computer program product of claim 20, wherein the computer readable program code to determine predefined operation patterns is further configured to determine semantically equivalent operations for operations in the predefined operation patterns.

23. The computer program product of claim 20, wherein the computer readable program code to determine predefined operation patterns is further configured to determine context representations for operations in the predefined operation patterns.

24. The computer program product of claim 20, wherein the computer readable program code to determine the set of coordination outcome requirement is further configured to receive the set of outcome requirements from the client.

25. The computer program product of claim 20, wherein the computer readable program code to observe client requests is further configured to intercept client requests to the service providers.

26. The computer program product of claim 20, wherein the computer readable program code to observe service provider responses is further configured to intercept service provider responses to the client.

27. The computer program product of claim 20, further comprising computer readable program code configured to determine if at least one coordination outcome requirement of the set of coordination outcome requirements is possible.

28. The computer program product of claim 20, further comprising computer readable program code configured to determine if the coordination outcome requirement has expired.
